(19) United States
(12) Patent Application Publication
(10) Pub. No.: US 2006/0206232 A1
(43) Pub. Date: Sep. 14, 2006

(54) Method and Device for Recognizing Defects in Textile Structures

(76) Inventors: Tim Palmer, Hertfordshire (GB); Beat Emch, Eglisau (CH)

Correspondence Address: BUCHANAN, INGERSOLL & ROONEY PC, POST OFFICE BOX 1404, ALEXANDRIA, VA, 22313-1404, US

(21) Appl. No.: 10/542,864

(22) PCT Filed: Dec. 17, 2003
(86) PCT No.: PCT/CH03/00820

§ 371 Date: May 16, 2006

(51) Int. Cl. G06F 19/00

(52) U.S. Cl. 700/143

(57) ABSTRACT

The invention relates to a method for detecting defects in a textile structure (2) by taking signals from the textile structure and processing the signals taken from the textile structure based at least on preset parameters and to an apparatus (3) for detecting defects in a textile structure comprising a sensor, a processing unit and an input/output unit, whereas said processing unit is connected to said sensor and to said input/output unit and is designed for processing signals taken from the textile structure by the sensor at least based on preset parameters and producing an output signal indicating the presence of a defect in the textile structure examined. In order to solve the problem of adjusting parameters of the method and apparatus for detecting faults in a flat textile structure to the specific flat textile structure presented for detecting defects, a physical data carrier (23) for presenting preset parameters to a sensor and said sensor for reading preset parameters from the physical data carrier is provided.

The invention relates to a method for detecting defects in a textile structure by taking signals from the textile structure and processing the signals taken from the textile structure based at least on preset parameters and to an apparatus for detecting defects in a textile structure comprising a sensor, a processing unit and an input/output unit, whereas said processing unit is connected to said sensor and to said input/output unit and is designed for processing signals taken from the textile structure by the sensor at least based on preset parameters and producing an output signal indicating the presence of a defect in the textile structure examined.

Defects in textile structures may appear in different ways. Examples may be variations of the physical structure of the textile sample, colour variations, defective yarns, isolated yarns with wrong dimensions introduced into the textile structure, foreign material in yarns or in the textile structure and so on. Defects are usually disturbing the visual appearance of the textile structure and may most often catch the eye of a human spectator to which such textile structure with defects is presented. Therefore, defects in this context are unwanted and to be eliminated as soon as possible.

Such method and apparatus is already known from WO 98/08080 whereas images taken from the textile structure are converted to brightness values of pixels. Such values are fed to a neural network filter. In order to progressively adapt filtering parameters to the actual textile structure presented to the sensor or camera, a learning phase is initiated in which different kinds of defects in the textile structure as well as error-free portions of the textile structure are presented to the sensor. During this procedure which takes place in advance to the detecting procedure, parameters of a filter are adjusted progressively. So, this step is to be seen as a learning phase for the filter. During this learning phase supposedly correct output signals are fed to the apparatus which then compares input signals and correct output signals in order to obtain the parameters needed for regular operation.

With this known method and device, such learning phase is to be performed each time a new fabric or web is introduced for detecting faults. This process is somewhat time consuming and it is not possible to use the inspection unit for regular inspection during this time.

The invention as claimed is intended to remedy these drawbacks. It solves the problem of adjusting parameters of the method and apparatus for detecting faults in a textile structure to the specific textile structure presented for detecting defects in a fast and simple manner.

This problem is solved by the present method where set-up or preset parameters for adapting the method and device to a specific textile structure are deposited in a readable representation, e.g. in a numeric and/or graphic representation on a physical data carrier. Said data carrier is presented to a sensor, which reads the numerical and/or graphic representation on the physical data carrier and thereby inputs the parameters. Said parameters are stored in a store or memory of a processing unit. Then, during normal operation, a textile structure is presented to the sensor in order to be examined and signals or images of the textile structure are taken by the sensor and transferred to the processing unit. This processing unit processes the said images or signals using preset and possibly also adaptive parameters stored in said store and previously read from said physical data carrier.

According to the present invention, the apparatus comprises a sensor, a processing unit and an input/output unit, whereas said processing unit is connected to said sensor and to said input/output unit and is designed for examining signals taken from the textile structure by the sensor based at least on preset parameters and producing an output signal indicating the presence of a defect in the textile structure examined. The sensor is designed for reading preset parameters in numerical or graphic representation from a physical data carrier which may be an instruction sheet and which in turn is designed to be presented to the sensor. Preferably the said sensor is designed as a single sensor for reading signals from both a textile structure to be examined and a physical data carrier having a numerical and/or graphic representation of preset parameters on it. On the physical data carrier different zones may be provided, each comprising a different kind of information. So, one zone will be provided for storing parameters for use when processing signals taken from the textile structure.

The advantages offered by the invention are mainly that the step of adjusting parameters of the detecting apparatus takes very little time. Therefore, the normal operation of the apparatus is not interrupted for long times once a new textile structure is to be processed. Additionally, the step of inputting set-up parameters to the apparatus is extremely easy and may be performed by operating staff trained on the job. Such training is extremely simple. Also the process of preparing a physical data carrier such as e.g. a instruction sheet of paper or a card can be performed off-line by specialised people working with state of the art equipment such as e.g. personal computers, scanners, printers and so on.

One way of carrying out the invention is described in detail below with reference to drawings which illustrate only one specific embodiment, in which

FIG. 1 is a perspective view of an inventive apparatus,

FIG. 2 is a schematic representation of a part of the apparatus shown in FIG. 1,

FIG. 3 is a detailed view of the apparatus shown in FIG. 1,

FIG. 4 is a representation of a physical data carrier used for inputting set-up parameters and

FIG. 5 is a view of further equipment which may be used in connection with the invention.

FIG. 1 shows part of a loom 1 on which a textile structure such as fabric 2 is woven in well known manner. An apparatus 3 for detecting defects in the fabric 2 is fastened to the said loom 1 and preferably extends over the whole width of the fabric 2 in the loom 1. The fabric 2 moves in a direction as indicated by arrow 4. The apparatus 3 also comprises a small input/output board 5 with buttons 6 for starting the functions of the apparatus 3 and a display 7 for messages in connection with the operation thereof.

FIG. 2 shows a schematic and simplified representation of elements present in the apparatus 3. A sensor 8 is shown close to a textile structure 9, which may be a fabric, a cloth, a web or similar textile structure. A processing unit 10 is connected to the sensor 8 and to an input/output device 11 by a bus 12 and 13. The processing unit 10 comprises a memory or store 14, an input interface 15 and a processor 16. The input interface 15 is connected through the bus 12 to the sensor 8. Transfer of data can be made between the said elements of the processing unit 10 especially but not exclusively as indicated by arrows 17, 18, 19. The sensor 8 may preferably be a CCD-camera, a CIS (Contact Image Sensor) or other type of imaging sensor. In cases, where the sensor 8 produces an analogue signal derived from the textile structure 9, then, an analog/digital converter 20 may also be present. The sensor 8 may read signals from the textile structure 9 to be examined or from a physical data carrier 23 of another type presented to it. In an alternative embodiment, the sensor 8 may comprise a special sensor 8a which extends in a restricted zone 21 and for especially reading signals from a physical data carrier 23 presented to it in said zone 21. The processing unit 10 also has an output line or bus 35 for emitting an output signal indicating the presence of a defect in the textile structure 9 examined.

FIG. 3 shows an enlarged view of a part of apparatus 3 shown in FIG. 1. The already known elements such as the fabric 2 and the input/output board 5 with buttons 6 and display 7 are shown. In a zone 21 of the apparatus 3, an input means 22 for introducing a physical data carrier 23 such as a sheet of paper, a piece of fabrics or plastic which may be an instruction sheet to the apparatus 3 is mounted. Such instruction sheet may be introduced into input means 22 manually or may be fastened to the fabric 2 and thereby introduced mechanically without using said input means 22.

FIG. 4 shows one face of such physical data carrier 23 or instruction sheet, which may be divided into several zones 24, 25 and 26, each comprising a different kind of information. For example zone 24 may contain information to be read by human eye. Such information may be read by people operating the apparatus and be related to a specific type of textile structure, a customer, a time, a loom and so on. Zone 25 may contain information related to the type of textile structure, here obviously a fabric, to kinds of defects, to previous treatment and so on. Zone 25 may also contain instructions to be read by the sensor 8. Zone 26 may contain numerical or graphic information about parameters of the processor 16 (FIG. 2) to be set. It is also possible to have other zones e.g. such zones where pictures are present. Such pictures may also represet different kinds of defects in the textile structure.

FIG. 5 shows possible devices used for establishing a physical data carrier 23 e.g. as shown in FIG. 4. From this figure a personal computer 27 which is connected to a printer 28 and a scanner 29 can be recognized. Of course the personal computer 27 also comprises a main unit 30, a display 31, a key-board 32 and a mouse 33.

In operation and before starting to examine a specific textile structure such as e.g. a piece of fabric 2, a physical data carrier 23 which may be an instruction sheet or other storage medium comprising information about the said fabric 2 and about the parameters to be used in the processing of data from said fabric 2 is established. Such physical data carrier 23 can be made or loaded with data e.g. by the manufacturer of the apparatus 3. Taking into account known and possible defects, known types of textile structures and the properties of the sensors used, it is possible to determine preset parameters during development or initial, pre-production testing of the apparatus 3. Once such preset parameters are known, the preset parameters are deposited on a set of physical data carriers 23. Such set may contain a physical data carrier 23 for most or all possible kinds of textile structures to be produced on a given machine or by a customer.

Another possibility is that a tool such as disclosed in FIG. 5 is provided to the operator of a given machine e.g. a loom. For determining preset parameters, for example a piece of the fabric 2 may be put onto the scanner 29 where it is scanned and the result is transferred to the personal computer 27. Thereby the personal computer 27 may get indications about the structure of the fabric, such as dimensions of yarn used, of density of yarns, of color or greyness values, of patterns or designs and so on. It is assumed that principles or algorithms used by the apparatus 3 to examine signals or pictures taken from the fabric 2 are known and loaded as a program into said personal computer 27. Such programs may be stored in the main unit 30 together with values for thresholds or other criteria that will be used for determining a defect in the fabric 2. WO 98/08080 and WO 00/06823 disclose methods for treating signals taken from a fabric and the manner in which thresholds can be defined for defining a limit between tolerable and untolerable defects in a fabric or other textile structure. Values needed for running testing algorithms and values needed for defining thresholds to be observed when detecting defects, are stored in the said main unit 30. This kind of storing values as said above is in fact well known and therefore not further disclosed here.

Starting from that and eventually from additional inputs made through the keyboard 32, the computer 27 may run a program, which will result in data to be stored on a physical data carrier such as e.g. a instruction sheet 23 where the information needed by the processing unit 10 is stored and may be read by the sensor 8 of apparatus 3. Button 6 on input/output board 5 may be used to switch the apparatus between a testing mode for normal testing operation and a loading mode, where information is read by the sensor 8 from the physical data carrier 23 into memory or store 14 of processor 10. When now turning to FIG. 2, it can be said that in the loading mode, the input interface 15 is loading information, that is essentially values of parameters from bus 12 into store 14 as indicated by arrow 17, whereas in the normal operating mode, the input interface 15 is transferring data from bus 12 to the processor 16 as indicated by arrow 19. In such case data transferred may represent pixels having different values for colors or for grey shades as emitted by the sensor or camera 8 or may also represent information provided by infrared radiation or other wavelengths. The switching between modes in the representation of FIG. 2 is initiated by instructions from the input/output device 11 to the processor 16.

If a defect in the fabric is detected, there are several possibilities to react. One possibility is to stop the loom 1, another is to display an information on display 7 or both at once, or simply to count the number of defects.

Typical values for parameters stored in zone 26 (FIG. 4) of the said physical data carrier or sheet 23 may be values for defining a filtering characteristic, different values for thresholds, whereas such thresholds may be different depending on the structure of the presented fabric, knitting or web and so on.

In zone 25 (FIG. 4) one may put information about warp or weft yarns, about defects, stains and other information to be defined (TBD). Such information may be introduced by the operator manually. Therefore, zone 25 shows several boxes such as box 35 which may be crossed with a pencil. The presence or absence of crosses in the boxes of zone 25 corresponds to a set of instructions to the apparatus 3. For example a cross in box 35 may instruct the apparatus 3 that defects in the warp having a length between 10 and 20 cm should be disregarded, or, especially treated in additional steps and so on. Information deposited on zone 25 may not necessarily be used in the detecting process but in the subsequent steps where such information may contribute to the manner to react to defects found. For example such information may define how fast a reaction should be or where an information about defects should primarily be directed to, or, if or how a statistics is to be made from defects found.

The said physical data carrier 23 which was already described as having a preferred form of a sheet of paper or plastics may also be a structure like a credit card or smart card or some other media for carrying information. In such case, printer 28 may be exchanged by a card machine or a machine of another type and the information loaded on it may not be visible as shown in our figures. In this case, the information stored on the physical data carrier 34 may not be read by the normal sensor 8, which is designed for imaging the tested textile structure, but, a special sensor 8a is to be incorporated into apparatus 3, preferably into input/output board 5. In such case the board 5 may have a special interface or connection for reading from or even writing to the physical data carrier 34 which may be a card or other storage means to be introduced therein. The physical data carrier 34 may also be designed to store data recorded by the apparatus 3 or board 5 and therefore to store e.g. information or results obtained during the operating procedure. Such information may relate to the type of defects, the position and or the number of defects and may be used to print documents such as reports to be issued once the said physical data carrier is again introduced in the device shown in FIG. 5. Stored information may also be presented in a form to be read by human eye from the physical data carrier 23. The device shown in FIG. 5 may also be designed and used to load a electronic storage medium 34. Therefor, the scanner 29 may be replaced by a corresponding device for reading from or writing information onto a memory chip.

1. Method for detecting defects in a textile structure by taking signals from the textile structure and processing the signals taken from the textile structure based at least on preset parameters, comprising the following steps: depositing said preset parameters in a readable representation on a physical data carrier, reading parameters from said physical data carrier and storing said parameters for use when processing signals taken from the textile structure, presenting a textile structure to be examined, detecting signals from the textile structure, and processing signals taken from the textile structure using parameters stored from the physical data carrier.

2. Method according to claim 1, wherein the preset parameters are stored on the physical data carrier in numeric or graphic form.

3. Apparatus for detecting defects in a textile structure comprising: a sensor, a processing unit and an input/output unit, whereas said processing unit is connected to said sensor and to said input/output unit and is designed for processing signals taken from the textile structure by the sensor at least based on preset parameters and producing an output signal indicating the presence of a defect in the textile structure, further including a physical data carrier for presenting preset parameters to a sensor and wherein said sensor reads preset parameters from the physical data carrier.

4. Apparatus according to claim 3, wherein said processing unit comprising a processor, an input interface connected to said sensor and a store for storing said preset parameters as read by said sensor.

5. Apparatus according to claim 3, wherein said sensor is designed as a single sensor for reading signals from the textile structure to be examined and for reading preset parameters from the physical data carrier.

6. Apparatus according to claim 3, wherein said physical data carrier is an instruction sheet.

7. Apparatus according to claim 3, wherein said physical data carrier is a electronic memory device.

8. Physical data carrier for use in apparatus according to claim 3, wherein different zones are provided each comprising a different kind of information.

9. Physical data carrier according to claim 8, wherein one zone is provided for storing parameters for use when processing signals taken from the textile structure.
